(19) United States
(12) Patent Application Publication
(10) Pub. No.: US 2021/0060870 A1
(43) Pub. Date: Mar. 4, 2021

(54) PROGRESSIVE FLOW-FORMING METHOD

(71) Applicant: Arris Composites Inc., Berkeley, CA (US)

(72) Inventors: Ethan ESCOWITZ, Berkeley, CA (US); Sam PIRAHANCHI, Novato, CA (US); Erick DAVIDSON, Piedmont, CA (US); J. Scott PERKINS, Oakland, CA (US); Riley REESE, Oakland, CA (US)

(21) Appl. No.: 17/008,187

(22) Filed: Aug. 31, 2020

Related U.S. Application Data
(60) Provisional application No. 62/894,437, filed on Aug. 30, 2019.

(51) Int. Cl. B29C 70/14; B29C 71/02; B29C 70/46

(52) U.S. Cl. CPC B29C 70/14; B29K 2105/0881; B29C 70/465; B29C 71/02

(57) ABSTRACT

A compression molding method for creating fine, features having desired fiber-alignment patterns involves creating a pressure gradient in a mold cavity during the soak phase of the compression-molding process. In the illustrative embodiment, the gradient is created by movement of a structure, and results in a flow of nearby fiber and melted resin. This alters local, preexisting, non-random fiber alignments. The process imparts geometries to a part (the bulging features) that are not otherwise present on the mold surface.

### STATEMENT OF RELATED CASES

This specification claims priority of U.S. Pat. Appl. 62/894,437, which was filed Aug. 30, 2019 and is incorporated by reference herein.

### FIELD OF THE INVENTION

The present invention relates to additive molding of fiber-composite materials.

### BACKGROUND

Any composite part consisting of fibers within a matrix material will exhibit mechanical and material properties that are a function of the orientation of its internal fibers. The matrix material possesses isotropic material properties, whereas the fibers present anisotropic properties that largely define the performance of the part. By controlling the orientation of the fibers, one skilled in the art can improve aspects of the performance of a composite part. For example, aligning fibers along the anticipated in-use principal stress vector(s) of the part maximizes structural performance of the part.

It is problematic to create local geometries in specific volumetric regions of a composite part, and even more challenging to create a desired fiber alignment in such volumetric regions.

### SUMMARY

The present invention provides a way, in a compression-molding process, to create, in a localized volumetric region of a part, fine features having a desired fiber alignment.

In accordance with the illustrative embodiments, one or more structures are used to impart geometries that are not present on the surface of (i.e., the walls that define) the mold cavity, or within the mold cavity itself. The movement of such structures creates a positive or negative pressure gradient in the mold cavity, resulting in a concomitant flow of the surrounding material (i.e., melted resin and fiber). This alters local, pre-established, non-random fiber alignments. By creating one or more of such localized pressure gradients, fine features having a desired fiber alignment are created at specific locations in a composite part.

The present invention addresses shortcomings of the prior art, and addresses limitations of applicant's own methods, discussed below, for creating fine features in a composite part and controlling the fiber alignment in such features.

Other than applicant's own prior art, there has been no teaching to create a desired fiber alignment within small, fine features in a part. In fact, with few exceptions, there is little ability in prior-art processes, particularly compression molding processes, to exercise substantial control fiber alignment.

Applicant has disclosed several methods for creating a desired fiber alignment in specific volumetric regions of a composite part. The feed constituents to such methods include one or more assemblages of fiber-bundle-based preforms. Such assemblages can be in the form of a “layup” of individual preforms, or, alternatively, tacked together as a “preform charge.” Each preform in the assemblage includes thousands of unidirectionally aligned fibers, which are impregnated with a polymer resin. Such preforms are typically segments of towpreg. The use of such preforms is integral to the ability of such methods to control fiber alignment in specific volumetric regions.

In one such method, as described in US 2020/0108568, cavities within volumetric regions of a compression mold are used to create localized pressure gradients during the compression process. Since the majority of the mold-cavity volume is occupied by the feed constituents, the empty space present in such discrete regions results in local pressure gradients as pressure is applied during the molding process. Under applied heat, the polymer resin in the preforms reaches its melt phase, and, with applied pressure, the resulting pressure gradients cause the resin to flow into the localized cavities. The viscosity of the polymer carries the fibers from the preforms with it, and these fibers align with the flow vectors of the polymer through shear forces. The direction and path of flow into the cavities yields aligned fibers in the “flowed” volumetric regions of the final part.

Alignment within these flowed regions is largely dependent on flow vectors resulting from mold geometry. Consequently, fiber alignment, as results from this method, is reliant on the flow that occurs as a result of the compression-molding process. That is, this method cannot be dynamically or sequentially controlled beyond traditional compression-molding parameters. Furthermore, it exposes very small flow features to high pressure, imparting significant internal stress that risks damage of such small features.

In a second of such methods developed by applicant, and as described in U.S. Ser. No. 16/911,254, localized pressure gradients for flowing and orienting fibers are created in a way that is independent of the geometry of the mold cavity and traditional compression-molding parameters. Rather, in this second method, localized pressure gradients are established based on the manner in which the preforms are positioned within the assemblage thereof, and based on the manner in which the assemblage is oriented within the mold cavity of a compression mold.

More particularly, the preforms in the layups or preform charges are oriented with respect to one another, and the mold itself, to create localized “cavities” at desired locations with the mold cavity proper. Localized cavities can be formed in several ways. If plural assemblages of preforms are to be placed in the mold cavity, they can be positioned to create gaps between neighboring assemblages, thereby creating a localized region of “empty” space between the assemblages. In another approach, the preforms within an individual assemblage (i.e., either a layup or preform charge) are positioned to create “empty” space within the assemblage. This can be done, for example, by stacking overlapping preforms at varying angles, so that at least some of the preforms in the assemblage are not co-planer/co-linear with others therein.

Once the polymer resin in the preforms has reached its melt phase, the presence of the empty spaces, under applied pressure, will result in pressure gradients that cause the melted resin to flow into the cavities resulting from the arrangement of preforms. Once again, the viscosity of the melted resin carries the preform-sourced fibers with it. Like the previously discussed method, this method similarly requires flow to occur as a result of the compression-molding process.

This flow method tends to be more turbulent than the previously described method. As a consequence of the shear forces present in this fluidic mixing, the fibers ultimately exhibit a higher degree of randomization than in applicant's previously described process. In fact, alignment within the flowed regions is largely dependent on the turbulent nature of fluidic mixing. Although the locations of the flow regions can be specified as desired by appropriate structuring of the assemblage of preforms, the method is limited in that the resulting randomized fibers are not necessarily desirable in all use cases. More particularly, this method is best suited for applications in which there are certain small volumetric regions in which the anticipated stress vectors for the in-use part are not uniform, but rather have different directions with relatively small changes in location.

Unlike applicant's previous methods, embodiments of the present invention are performed after the feed material has fully melted, consolidated, and filled the mold cavity. Actuation of the pressure-gradient inducing (“PGI”) structure, and the subsequent flow of melted resin, is not reliant on compression as the motive force. Rather, in accordance with embodiments of the invention, the pressure gradient being created relies solely on the timing of actuation of the PGI structure(s). This enables the introduction of a pressure gradient to yield local flow in otherwise non-flowed, long-fiber regions along the surface of a part. This facilitates more consistent alignment patterns of long, continuous fibers within flowed (typically fine) features.

Furthermore, the actuation of the PGI structure, or multiple PGI structures, can be performed either towards the internal region of the mold for an inward-bulging feature in the final part, or away from the internal region of the mold for an outward-bulging feature in the final part.

Although applicant's other methods, as referenced above, can produce desirable regions of aligned or randomized fiber in a composite part, they are subject to the process constraints of compression molding. In particular, the constraint of needing to flow the polymer/fibers while the assemblage of preforms is being consolidated through heat and pressure.

In some embodiments, the invention provides a compression-molding method for forming a feature in a part, the compression molding method comprising:

placing an assemblage of fiber-bundle-based preforms in a mold cavity, wherein the assemblage is arranged to achieve a first non-random fiber alignment throughout a part being molded, each fiber-bundle-based preform comprising fiber and resin;

fully consolidating the fiber-bundle-based preforms in the assemblage by the application of heat and pressure, thereby attaining a soak phase of the compression molding process, and wherein the first non-random fiber alignment is achieved;

altering, during the soak phase, the first non-random fiber alignment to a second non-random fiber alignment at a first location by moving a first structure either:
(a) into the mold cavity to a first position to form, in the part, a first feature that bulges inward, or
(b) away from the mold cavity to a second position to form, in the part, a second feature that bulges outward; and

cooling the fiber and resin, wherein the first position or the second position of the first structure is maintained until a temperature of the resin drops below a glass transition temperature thereof, thereby fixing the second non-random fiber alignment to form the first or second feature in the part.

In some embodiments, the invention provides a compression-molding method for forming a feature in a part, the compression molding method comprising:

placing an assemblage of fiber-bundle-based preforms in a mold cavity, wherein the assemblage is arranged to achieve a first non-random fiber alignment throughout a part being molded, each fiber-bundle-based preform comprising fiber and resin;

fully consolidating the fiber-bundle-based preforms in the assemblage by the application of heat and pressure, thereby attaining a soak phase of the compression molding process, and wherein the first non-random fiber alignment is achieved;

inducing, during the soak phase, a pressure gradient at a first location in the mold cavity, wherein the pressure gradient alters the first non-random fiber alignment to a second non-random fiber alignment at the first location.

In some embodiments, the invention provides a compression mold for forming a feature in a part, wherein the feature bulges outward or inward relative to a surface of the part, the compression molding method comprising:

a mold wall;

a mold cavity defined by an inner surface of the mold wall;

a movable structure, wherein, in a quiescent state, a surface of the movable structure forms a portion of the inner surface of the mold wall;

an actuation system, wherein the actuation system is physically adapted to cause the movable structure to move either:
(a) into the mold cavity, or
(b) away from the mold cavity.

In further embodiments, the invention provides a method for compression molding and a compression mold that includes at least one of the features, in any (non-conflicting) combination, disclosed herein and in the appending drawings.

### BRIEF DESCRIPTION OF THE DRAWINAS

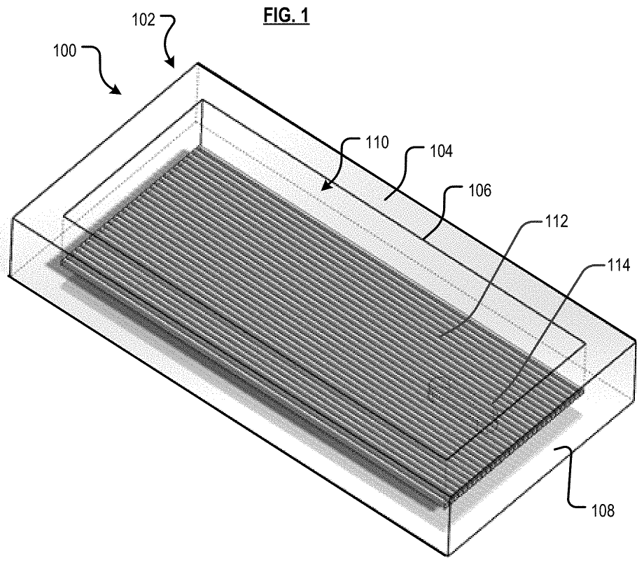

FIG. 1 depicts the bottom-most layer of fibers in a fully closed compression mold. The polymer matrix, remaining fibers, and top mold half have been omitted for clarity.

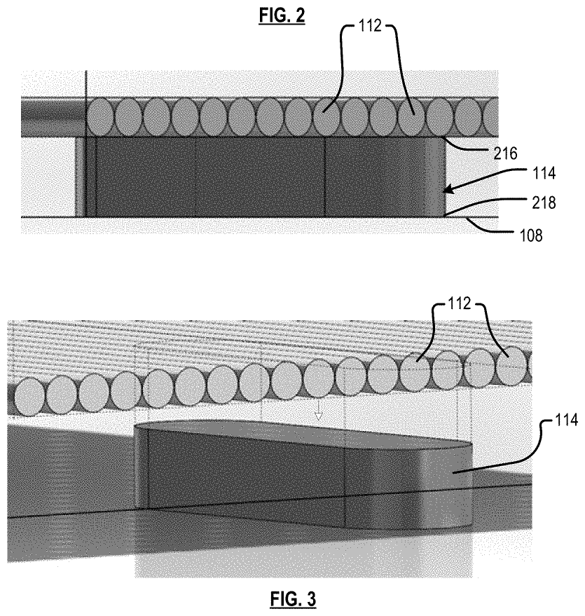

FIG. 2 depicts a PGI structure for use in conjunction with the illustrative embodiment of the invention, wherein the PGI structure is depicted before actuation.

FIG. 3 depicts the PGI structure of FIG. 2 immediately after actuation, but before the fibers have displaced downward.

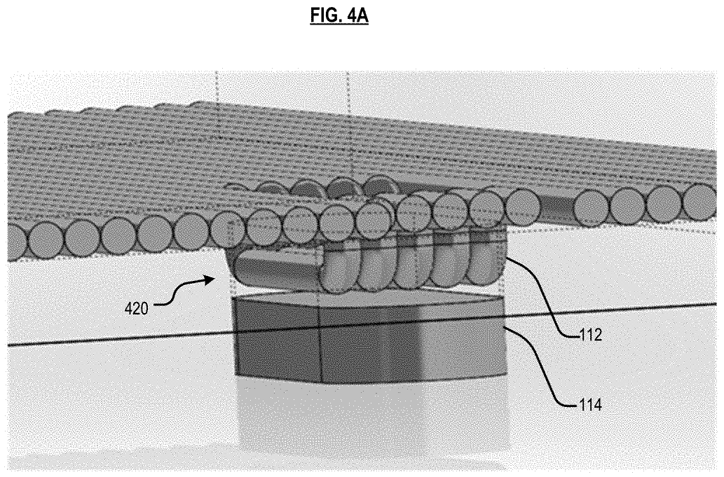

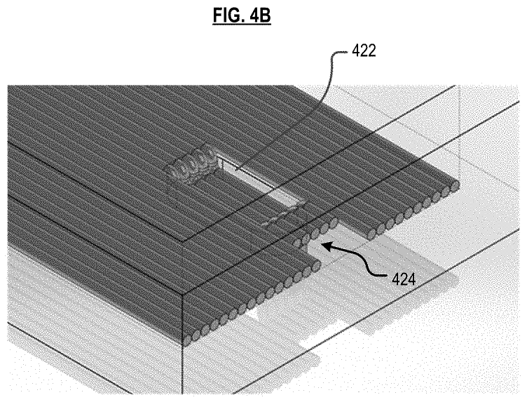

FIGS. 4A and 4B depict downward movement of the fibers as a consequence of the downward pressure gradient created by downward movement of the PGI structure.

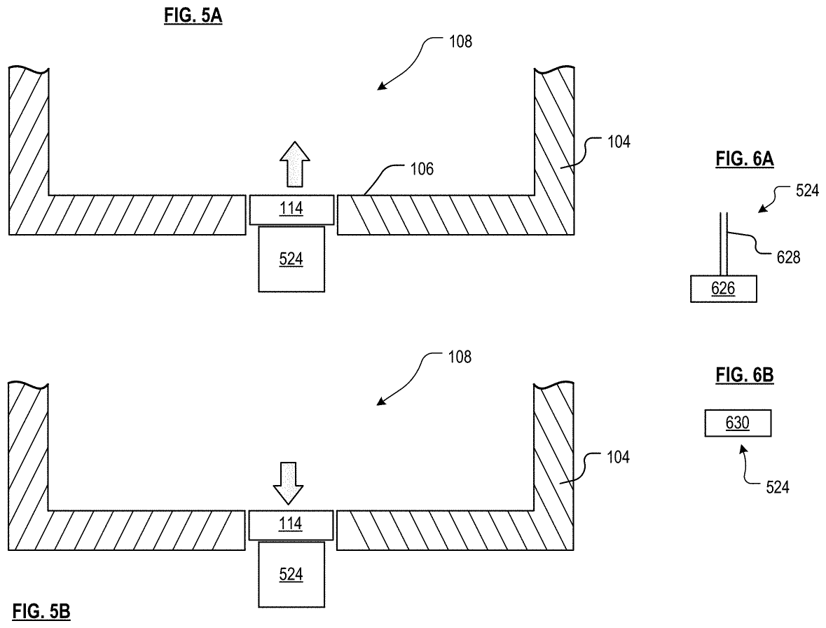

FIGS. 5A and 5B depict actuation arrangements for creating inwardly bulging features and outwardly bulging features, respectively.

FIGS. 6A and 6B depict further detail about the actuation arrangements of FIGS. 5A and 5B.

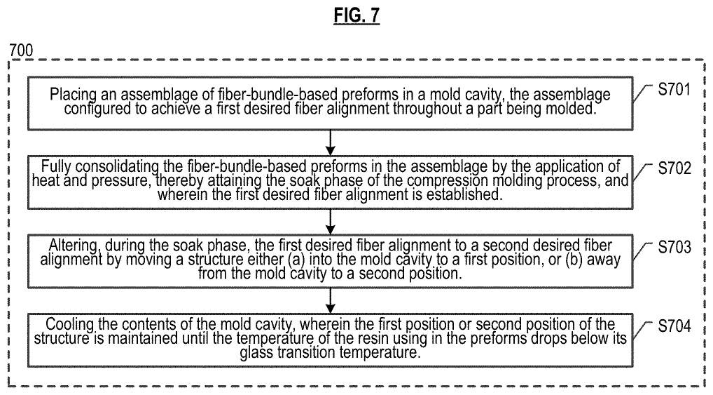

FIG. 7 depicts a method in accordance with the illustrative embodiment of the invention.

### DETAILED DESCRIPTION

The following terms, and their inflected forms, are defined for use in this disclosure and the appended claims as follows:
“Fiber” means an individual strand of material. A fiber has a length that is much greater than its diameter. For use herein, fibers are classified as (i) continuous or (ii) short. “Continuous fibers” have a length that is no less than about 60 percent of the length of a mold feature or part feature where they will ultimately reside. Hence, the descriptor “continuous” pertains to the relationship between the length of a fiber and a length of a region in a mold or part in which the fiber is to be sited. For example, if the long axis of a mold has a length of 100 millimeters, fibers have a length of about 60 millimeters or more would be considered “continuous fibers” for that mold. A fiber having a length of 20 millimeters, if intended to reside along the same long axis of the mold, would not be “continuous.” Such fibers are referred to herein as “short fibers.” The term “short fiber,” as used herein, is distinct from the “chopped fiber” or “cut fiber,” as those terms are typically used in the art. In the context of the present disclosure, short fibers are present in a preform (of the same length), and substantially all short fibers in the preform are unidirectionally aligned. As such, the short fibers will have a defined orientation in the preform layup or preform charge in the mold and in the final part. As used in the art, “chopped” or “cut” fiber has a random orientation in a mold and the final part. Returning to the example of the 20-millimeter fiber, it is notable that if that fiber is intended for a feature in the mold having a length of about 20 millimeters, then the fiber would be considered to be “continuous.” For features that are smaller than the overall size of the mold, the fibers will typically be somewhat longer than the feature, to enable “overlap” with other fibers. For a small feature, the overlap amount could represent the major portion of the length of the fiber.
“Fiber bundle” means plural (typically multiples of one thousand) unidirectionally aligned fibers.
“Compatible” means, when used to refer to two different resin materials, that the two resins will mix and bond with one another.
“Stiffness” means resistance to bending, as measured by Young's modulus.
“Tensile strength” means the maximum stress that a material can withstand while it is being stretched/pulled before “necking” or otherwise failing (in the case of brittle materials).
“Tow” means a bundle of unidirectional fibers, (“fiber bundle” and “tow” are used interchangeably herein unless otherwise specified). Tows are typically available with fibers numbering in the thousands: a 1K tow, 4K tow, 8K tow, etc.
“Prepreg” means fibers, in any form (e.g., tow, woven fabric, tape, etc.), which are impregnated with resin.
“Towpreg” or “Prepreg Tow” means a fiber bundle (i.e., a tow) that is impregnated with resin.
“Preform” means a segment of plural, unidirectionally aligned fibers. The segment is cut to a specific length, and, in many cases, will be shaped (e.g., bent, twisted, etc.) to a specific form, as appropriate for the specific part being molded. Preforms are usually sourced from towpreg (i.e., the tow-preg is sectioned to a desired length), but can also be from another source of plural unidirectionally aligned fibers (e.g., from a resin impregnation process, etc.). The cross section of the preform, and the fiber bundle from which it is sourced typically has an aspect ratio (width-to-thickness) of between about 0.25 to about 6. Nearly all fibers in a given preform have the same length (i.e., the length of the preform) and, as previously noted, are unidirectionally aligned. The modifier “fiber-bundle-based” or “aligned fiber” is often pre-pended, herein, to the word “preform” to emphasize the nature of applicant's preforms and to distinguish them from prior-art preforms, which are typically in the form of segments of tape or in the form of a shape cut from sheets of fiber. Applicant's use of the term “preform” explicitly excludes any size of shaped pieces of: (i) tape (typically having an aspect ratio—cross section, as above—of between about 10 to about 30), (ii) sheets of fiber, and (iii) laminates. Regardless of their ultimate shape/configuration, these prior-art versions of preforms do not provide an ability to control fiber alignment in a part in the manner of applicant's fiber-bundle-based preforms.
“Consolidation” means, in the molding/forming arts, that in a grouping of fibers/resin, void space is removed to the extent possible and as is acceptable for a final part. This usually requires significantly elevated pressure, either through the use of gas pressurization (or vacuum), or the mechanical application of force (e.g., rollers, etc.), and elevated temperature (to soften/melt the resin).
“Partial consolidation” means, in the molding/forming arts, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Preform Charge” means an assemblage of (fiber-bundle-based/aligned fiber) preforms that are at least loosely bound together (“tacked”) so as to maintain their position relative to one another. Preform charges can contain a minor amount of fiber in form factors other than fiber bundles, and can contain various inserts, passive or active. As compared to a final part, in which fibers/resin are fully consolidated, in a preform charge, the preforms are only partially consolidated (lacking sufficient pressure and possibly even sufficient temperature for full consolidation). By way of example, whereas a compression-molding process is typically conducted at about 150-1000 psi (which will typically be the destination for a preform-charge in accordance with the present teachings), the downward pressure applied to the preforms to create a preform charge in accordance with the present teachings is typically in the range of about 10 psi to about 100 psi. Thus, voids remain in a preform charge, and, as such, the preform charge cannot be used as a finished part.
“Planar” means having a two-dimensional characteristic. The term “planar” is explicitly intended to include a curved planar surface. For example, the “sheet” portion of the rib-and-sheet part, which is considered to be planar, can be curved or flat.
“About” or “Substantially” means+/−20% with respect to a stated figure or nominal value.

Other than in the examples, or where otherwise indicated, all numbers expressing, for example, quantities of ingredients used in the specification and in the claims are to be understood as being modified in all instances by the term “about.” Accordingly, unless indicated to the contrary, the numerical parameters set forth in the following specification and attached claims are understood to be approximations that may vary depending upon the desired properties to be obtained in ways that will be understood by those skilled in the art. Generally, this means a variation of at least +/−20%.

Also, it should be understood that any numerical range recited herein is intended to include all sub-ranges encompassed therein. For example, a range of “1 to 10” is intended to include all sub-ranges between (and including) the recited minimum value of about 1 and the recited maximum value of about 10, that is, having a minimum value equal to or greater than about 1 and a maximum value of equal to or less than about 10.

Feed Constituents.

The feed constituents used in conjunction with the methods described herein include a plurality of fiber-bundle-based/aligned fiber “preforms,” arranged into an assemblage thereof. Each fiber-bundle-based preform includes many individual, unidirectionally aligned fibers, typically in multiples of a thousand (e.g., 1k, 10k, 24k, etc.). The fibers align with the major axis of their host preform.

These fibers are typically sourced from a spool of towpreg. That is, the preforms are segments of towpreg, cut to a desired length and shaped, as appropriate for the application. As known to those skilled in the art, in towpreg, the fibers are impregnated with a polymer resin. In some other embodiments, the bundle of fibers can be sourced directly from impregnation processes, as known to those skilled in the art. Whatever the source, the fiber bundles, and hence the preforms, can have any suitable cross-section, such as, without limitation, circular, oval, trilobal, and polygonal.

The preforms are formed using a cutting/bending machine. The formation of a preform involves appropriately bending towpreg, or some other source of a plurality of unidirectionally aligned resin-impregnated fibers, typically via a robot or other appropriate mechanism, then cutting the bent portion of the fiber bundle to a desired length. As appropriate, the order of the bending and cutting can be reversed. As used herein, the term “preform” means “fiber-bundle-based preform,” as described above, unless otherwise indicated.

The assemblage of preforms can be implemented either as (1) a “preform charge,” or (2) a “layup” of loose preforms.

A preform charge comprises one or more fiber-bundle-based preforms that are tacked (joined) together. The preform charge, which is typically a three-dimensional arrangement of preforms, is usually created in a fixture separate from the mold, and which is dedicated and specifically designed for that purpose. To create a preform charge, one or more preforms are placed (either automatically or by hand) in a preform-charge fixture. By virtue of the configuration of the fixture, the preforms are organized into a specific geometry and then tacked together. Tacking can be performed by heating the preforms and then pressing them together. Other techniques for tacking/joining include ultrasonic welding, friction welding, lasers, heat lamps, chemical adhesives, and mechanical methods such as lashing.

After tacking, the preform charge is not fully consolidated. However, once the preforms are joined, they will not move, thereby maintaining the desired geometry and the specific alignment of each preform in the assemblage. The shape of the preform charge usually mirrors that of an intended part, or a portion of it. See, e.g., Publ. Pat. App. US2020/0114596 and U.S. patent application Ser. No. 16/877,236, incorporated herein by reference.

As indicated, as an alternative to using a preform charge, a layup (having the same configuration as the preform charge) of one or more individual preforms is created in the mold cavity. However, for both process efficiency as well a substantially greater likelihood that the desired preform alignment is maintained, the use of a preform charge is preferred. As used in this disclosure and the appended claims, the term “assemblage of preforms” either a “preform charge” or a “layup” of preforms, unless otherwise indicated.

In some embodiments, each preform in an assemblage of preforms has the same composition as all other preforms (i.e., the same fiber type, fiber fraction, and resin type). However, in some other embodiments, some of the preforms can differ from one another. For example, there may be instances in which different properties are desired at different regions within a complex part. Furthermore, if more than one assemblage of preforms is present in the mold cavity, the preforms in one assemblage can be the same or different than those in other assemblages in the cavity.

It is preferable, but not necessary, for all preforms to include the same resin. But to the extent different resins are used in different preforms or different assemblages, they must be “compatible,” which means that they will bond to one another. A preform assemblage can also include inserts that are not fiber based.

The individual fibers in a preform can have any diameter, which is typically, but not necessarily, in a range of 1 to 100 microns. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, glass, natural fibers, aramid, boron, metal, ceramic, polymer filaments, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Furthermore, carbon nanotubes can be used. Hybrid yarns consisting of twisted or commingled strands of fibers and polymer filaments can also be used as preforms.

Suitable resins for use in conjunction with the embodiments of the invention include any thermoplastic. Exemplary thermoplastic resins useful in conjunction with embodiments of the invention include, without limitation, acrylonitrile butadiene styrene (ABS), nylon, polyaryletherketones (PAEK), polybutylene terephthalate (PBT), polycarbonates (PC), and polycarbonate-ABS (PC-ABS), polyetheretherketone (PEEK), polyetherimide (PEI), polyether sulfones (PES), polyethylene (PE), polyethylene terephthalate (PET), polyphenylene sulfide (PPS), polyphenylsulfone (PPSU), polyphosphoric acid (PPA), polypropylene (PP), polysulfone (PSU), polyurethane (PU), polyvinyl chloride (PVC).

Fiber Alignment.

Embodiments of the invention are directed to achieving a desired fiber alignment throughout the part, and, further, in one or more discrete regions of a part, the latter achieved by creating pressure gradients that result from the actuation of PGI structures.

For a relatively simple part, it is within the capabilities of those skilled in the art to determine a desired fiber alignment to satisfy part requirements based on anticipated loading conditions. That is, based on their experience, those skilled in the art will be able to estimate the anticipated principle stress vectors arising in an in-use part, and know where in the part the fibers should be positioned, and how they should be aligned, to provide the requisite part performance.

For more complicated scenarios, either as consequence of part geometry, the forces to which the part is subjected in use, or both, the anticipated principle stress vectors can be determined, for example, using the techniques disclosed in Pub. Pat. App. US2020/00130297, incorporated by reference herein. Briefly, that application discloses: (a) developing a description of the part's geometry, (b) developing a description of the part's anticipated loading conditions, and (c) performing a finite element analysis (FEA) on the part geometry to calculate the stress under load. This results in a three-dimensional principal stress contour map for the interior of the component. The referenced publication discloses that by considering the orthotropic material properties at hand, a preform “map” (i.e., a preform layout/arrangement) can be developed from the principal stress contour map, such as by using a technique that determines “low-cost” routing. See also, U.S. patent application Ser. No. 16/811,537.

Regarding step (c) above, for every point in a given part with a given load case, there exists a stress state with six stresses aligned with the x, y, z axes and the shear stresses between them. If one rotates that stress state such that the shear stresses go to zero, the result is three, mutually orthogonal principal stresses. Each principle stress has a magnitude (which can be zero) and a direction; hence “stress vector.” The directions are orthogonal to one another. This stress tensor can rotate and change in magnitude from one element (in the finite element analysis) to the next.

A determination as to the nature of the fiber alignment in any particular region considers the principal stress tensors in that region. If the maximum or minimum principal stress is significantly larger than the other two, and follows a straight line or curves in a certain direction, fibers (in the part) can be aligned therewith, with few if any fibers being aligned in other directions (“off-axis” directions). If, on the other hand, a region has two or more principal stresses with substantially similar magnitudes, then, ideally, fibers should be aligned in multiple directions (i.e., the directions of the principal stresses) or randomized in an attempt to address the plural directions of such stresses.

Compression Molding with Fiber-Bundle Based Preforms in Accordance with Applicant's Prior Processes.

Some of applicant's prior compression-molding processes for fiber-bundle based/aligned fiber preform charges proceeds as follows. The preform charges, as well as any “loose” preforms, are first loaded into the mold cavity and placed in a molding apparatus that supplies heat and pressure. The geometry and arrangement of the preforms in the preform charge facilitate achieving the desired fiber alignment in the part being molded.

A specified amount heat (dependent on the resin chosen) and pressure are then applied to the materials within the mold by the molding apparatus for a period of time. The applied pressure is usually in the range of about 100 psi to about 300 psi, and temperature, which is a function of the particular resin being used, is typically in the range of about 150° C. to about 400° C. Elevated pressure and temperature are typically maintained for a few minutes.

Once the applied heat has increased the temperature of the resin above its melt temperature, it is no longer solid; the resin will then conform to the mold geometry via the applied pressure. The material is fully consolidated at this point, and the mold has pressed it into the shape of the final part. By matching the volume of material added to the mold to the volume of the mold, the material fills the cavity entirely.

The material is held above its melt temperature and under elevated pressure at full consolidation for several minutes. This ensures that the fluid polymer resin diffuses across the boundaries defined by the original subunits (i.e., preforms) within the preform charge. This process step is referred to as the “soak” phase. Once the soak phase is complete, heat is removed from the mold until the material has adequately cooled. Having obtained its final geometry as a finished part, it is then ejected from the mold. In addition to the final geometry, the final fiber alignment pattern within the part's volume is specified primarily by the original configuration of the preform charge.

In applicant's prior methods, the non-flowed regions of long, continuous fibers have maintained their alignment based on the geometry of the preform-charge and have reached their final locations within the solidified polymer matrix. The long and continuous nature of the fibers is notably present in volumetric regions along the surface of the mold. These fibers are longer than the fine feature(s) formed by the present invention.

Compression Molding with Fiber-Bundle Based Preforms in Accordance with Embodiments of the Invention.

In accordance with the present teachings, fibers can be highly organized in the discrete, volumetric regions. During the soak phase, the fibers are situated as they would be in compression-molding processes not employing the invention. In a process not employing the invention, this would be the final locations of the fibers in the cavity, attained by means of a pressure gradient created by virtue of compression. By contrast, and in accordance with the present teachings, fiber alignment is progressively altered during the soak phase by the actuation of PGI structure(s) to induce a localized pressure gradient.

Actuation—movement—of the PGI structure(s) occurs at any time during the soak phase of the compression-molding cycle. During this phase, actuation of the PGI structure imparts its associated geometry into the melted constituency. Similar to a compression-mold surface, the geometry of the PGI structure(s) is the inverse of the surface it forms in the part.

Prior to actuation, the PGI structure's effect on the cavity geometry is negligible (the structure is typically indistinguishable from the rest of the wall that defines the mold cavity). Rather, the PGI structure defines a local surface-area geometry of the cavity after actuation. Actuation of the PGI structure creates an associated change in the volume of the fully closed mold cavity, via a change in total surface area. This sudden change in volume creates a resultant pressure gradient, thereby pushing or pulling material along the path of motion of the structure.

Since the fibers are highly organized in regions immediately adjacent to the structure (based, for example, on the layout of preforms in the assemblage), they flow as dictated by the pressure gradient along the structure in a manner more organized than previous flow methods. Consider that it is challenging to push a fiber when the resin matrix is in the melt phase (i.e., like pushing a rope). But a pressure gradient that effectively pulls the fibers, for example, into an outward-bulging part feature will further benefit alignment within the feature.

Once actuated, the PGI structure holds its actuated position until the temperature of the resin drops below its glass transition temperature, after which the geometry imparted by the PGI structure is preserved, along with the global geometry created by the mold. Return of the PGI structure to its initial position can be performed before, during, or after ejection of the part, depending on geometric constraints required to eject the part without damage.

The present invention enables flowed features (features created by virtue of the flow of pressure-gradient-induced flow of resin), which are typically small, fine features, to be created progressively via the timed actuation of PGI structures during the soak period, as opposed to during the mold-filling phase of a compression-molding process. This approach results in having the highly organized and aligned fibers (prior to actuation) exposed to a sudden pressure gradient. The result of which is a higher degree of fiber organization around the flowed feature than is possible with other flow-based methods. Furthermore, in some embodiments, successive actuations of the PGI structure is used to create a single feature that could not otherwise be formed via a single actuation of the PGI structure.

The forming of localized features and fiber-alignment patterns can occur perpendicular or parallel to axis of movement of PGI structure. Progressive actuations can occur in isolation, in combination, or in sequence. Combination actuations are defined to be those in which two or more PGI structures impart an equal number of unique geometries or small features in a part. Sequential actuations are defined as those in which two or more PGI structures impart two or more geometric aspects into a single formed feature.

Furthermore, in some embodiments, combination and sequential actions can be employed in tandem. For example, in some embodiments, a first actuation creates a first aspect of a feature, and then subsequent actuations nested within its surface area further define the feature. Consider, for example, a first PGI structure in the form of sleeve in which a second PGI structure resides. The first PGI structure creates a first boss/emboss on a part surface, and the second PGI structure creates a second boss/emboss on the first boss/emboss, etc. Stepped features, for example, could be formed in this fashion. Provided the actuations are made mechanically compatible, nested PGI structures are not necessarily required to act on a common axis. That is, the actuation axis of the various PGI structures need not be collinear or even parallel, as long as there is no interference between the movement of each structure.

The PGI structures can be actuated in a variety of ways. The force to drive the motion can be provided by electromechanical, pneumatic, hydraulic, spring, magnetic, and/or mechanical sources. Timing of the motion during compression molding can be controlled via:
process-control logic;
variable spring stiffness triggered by process pressure and/or sequential action;
mechanical control surfaces or contacts, and/or;
manually by an operator.
   Any combination of driving forces and timing control methods is equally viable given proper specifications. Once pressure in a mold cavity reaches a specified level, for example, the spring stiffness controlling one PGI structure could be overcome to trigger actuation. This actuation could in turn trigger sequential actions based on a hierarchy of spring stiffnesses.

As with any compression-molding process, the incompressibility of the constituent polymer resin requires that the feed input volume match or slightly exceed the volume of the fully closed mold cavity. The actuation of the PGI structures will change the volume of the fully closed mold cavity, so this volume change must be considered. For example, PGI structures creating inward-bulging features cause an effective decrease in cavity volume. This can be addressed by underfilling the mold volume prior to actuation, or by flashing-out excess material. PGI structures creating outward-bulging features cause an effective increase in cavity volume. This can be addressed by actuating the PGI structure immediately before a mold has fully closed (so that additional material can be added), or in conjunction with simultaneously actuating inward-bulging counterparts that keep the change in effective cavity volume at net zero.

To maintain the requisite amount of material in the cavity, a secondary material-injection sequence can be implemented at the same time that the outward-bulging feature is created, while a mold is fully closed. In such an embodiment, a volume of material equal to the corresponding outward-bulging feature would be injected into the mold at a separate location by means of a nozzle within the cavity.

In some embodiments, movement that creates outward-bulging features can be used to promote fiber alignment along the surface affected by the motion. Specifically, as outward-bulging features increase cavity volume, the resultant pressure gradient draws material into the resulting volumetric region. The pull resulting from this pressure gradient applies some degree of tensile force to adjacent fibers, thus acting to straighten them (i.e., akin to removing slack in a rope). For example, fibers flowed into a static cavity during the compression molding process can be further aligned by actuating a pressure-gradient generating structure properly situated within the flow region. Using this approach, fiber alignment, which is initially highly dependent on flow vectors, becomes less so, and can therefore be altered to a more optimal alignment.

FIG. 7 depicts method 700 in accordance with the illustrative embodiment of the present invention. In accordance with operation S701, an assemblage of fiber-bundle-based preforms is placed in a mold cavity, wherein the assemblage is configured to achieve a first desired fiber alignment throughout a part being molded. Per operation S702, the preforms in the assemblage are fully consolidated by the application of heat and pressure. At this point, the compression molding process is in its soak phase, and the first desired fiber alignment is achieved.

In operation S703, the first desired fiber alignment is altered, during the soak phase, to a second desired fiber alignment, by moving a PGI structure either into the mold cavity to a first position, or away from the mold cavity to a second position. The surface of the PGI structure, in its quiescent state, is coincident with the surface of the mold cavity (see FIGS. 5A, 5B). Movement of the PGI structure creates a pressure gradient that pulls nearby fibers along the gradient, thus creating a second desired fiber alignment. Since the fibers are well organized prior to creation of the gradient, and since only a portion of each nearby fiber is moving, the moving portions of the fibers tend to maintain their orientation relative to one another.

If the PGI structure moves into the mold cavity, an inward-bulging feature is created. If the PGI structure moves away from the mold cavity (i.e., into the mold wall), an outward-bulging feature is created. Finally, in operation S704, the contents of the mold cavity is cooled, wherein the position of the structure (either the first position or the second position) is maintained until the temperature of the resin (originally present in the preforms) drops below its glass transition temperature.

FIG. 1 depicts the bottommost layer of fibers 112 in bottom mold half 102 of a fully closed compression mold 100. The polymer resin, the remaining fibers, and the top mold half have been omitted for clarity. In FIG. 1, the system is assumed to be in the soak phase of the compression molding process, wherein the polymer resin has melted.

Bottom mold half 102 includes mold wall 104, cavity wall 106, and cavity 110. Pressure-gradient generating (“PGI”) structure 114 is situated below the bottom layer of fibers 112. The fibers are highly organized immediately above PGI structure 114 due to their arrangement in assemblage of preforms originally placed in compression mold 100.

FIG. 2 depicts a side view of PGI structure 114 below fibers 112. In the state depicted in FIG. 2, PGI structure 114 has not yet been actuated. Lower surface 218 of PGI structure 114 is flush with outer surface 108 of mold wall 104. Upper surface 216 of PGI structure 114 is adjacent to the lower surface of the bottom layer of fibers 112.

FIG. 3 depicts PGI structure 114 immediately after it's been actuated; it has dropped relative to fibers 112. (mechanism for applying force to the structure and timing control for its motion are omitted for clarity).

In this example, the path of motion is linear; that is, normal to the mold surface. This will create a outward-bulging feature. This increase in volume creates a pressure gradient that applies (pulling) force to fibers 112 directly above, drawing them downwards soon after the surface is actuated.

FIGS. 4A and 4B depict the state of immediately overlying fibers 112 once they have responded to the pressure gradient created by the downward movement of PGI structure 114. The pressure gradient has pulled the directly overlying fibers 112 downwardly to create alignment within the new geometry. The highly organized orientations of the fibers have notably been preserved through this operation, resulting in a desirable alignment within outward-bulging feature 420. Gaps 422 and 424 (FIG. 4B) that result from the downward movement of fibers 112 can be balanced with corresponding PGI structures that create an inwardly bulging feature or by providing excess material in mold 100.

FIGS. 5A and 5B depict an embodiment of actuation system 524 for PGI structure 114. In FIG. 5A, actuation system 524 is configured to create an inward-bulging feature. In FIG. 5B, actuation system 524 is configured to create an outward-bulging feature.

In its quiescent state, upper surface of PGI structure 114 is flush with cavity wall 106. In the arrangement of FIG. 5A, when actuated, PGI structure 114 moves upwardly in the direction of the arrow into cavity 108. In the arrangement of FIG. 5B, when actuated, PGI structure 114 moves downwardly in the direction of the arrow through mold wall 104.

Since the mold cavity will be subject to very high pressures during the compression molding process, there must be tight tolerances between PGI structure 114 and elements of actuation system 524 and the mold. Other adaptations, such as gaskets, etc., may suitably be used so that the cavity can maintain the requisite pressure.

In some embodiments, such as depicted in FIG. 6A, actuation system 524 can include “driver” 626 and linkage 628. The driver is the source of the force that drives the motion, and linkage 628 conveys the force to PGI structure 114. An example of this type of actuation system is a linear actuator. The linear actuator can be driven by, for example and without limitation, an electromechanical device (linear motor), a hydraulic pump, a pneumatic actuator (cylinder/piston arrangement driven by compressed gas). Linkage 628 can be a rod, cylinder, etc.

In some embodiments, such as depicted in FIG. 6B, actuation system 524 does not require a separate linkage, per se. Examples of such a system include a spring (the spring functions as both the source of force and the linkage, or a magnet/electromagnet. In the case of a magnet/electromagnet, PGI structure 114 must include a material that responds to the magnetic field of the actuating magnet/electromagnet.

Timing of the actuation during compression molding can be controlled via:
process-control logic;
variable spring stiffness triggered by process pressure and/or sequential action;
mechanical control surfaces or contacts, and/or;
manually by an operator.
   Any combination of driving forces and timing control methods is equally viable given proper specifications. Once pressure in a mold cavity reaches a specified level, for example, the spring stiffness controlling one pressure-gradient generating structure could be overcome to trigger actuation. This actuation could in turn trigger sequential actions based on a hierarchy of spring stiffnesses.

It is to be understood that the disclosure describes a few embodiments and that many variations of the invention can easily be devised by those skilled in the art after reading this disclosure and that the scope of the present invention is to be determined by the following claims.

What is claimed:

1. A compression-molding method for forming a feature in a part, the compression molding method comprising:
placing an assemblage of fiber-bundle-based preforms in a mold cavity, wherein the assemblage is arranged to achieve a first non-random fiber alignment throughout a part being molded, each fiber-bundle-based preform comprising fiber and resin;
fully consolidating the fiber-bundle-based preforms in the assemblage by the application of heat and pressure, thereby attaining a soak phase of the compression molding process, and wherein the first non-random fiber alignment is achieved;
altering, during the soak phase, the first non-random fiber alignment to a second non-random fiber alignment at a first location by moving a first structure either:
(a) into the mold cavity to a first position to form, in the part, a first feature that bulges inward, or
(b) away from the mold cavity to a second position to form, in the part, a second feature that bulges outward; and
cooling the fiber and resin, wherein the first position or the second position of the first structure is maintained until a temperature of the resin drops below a glass transition temperature thereof, thereby fixing the second non-random fiber alignment to form the first or second feature in the part.

2. The method of claim 1 wherein the altering comprises inducing a pressure gradient by moving the first structure.

3. The method of claim 1 comprising altering, during the soak phase, the first non-random fiber alignment to a third non-random fiber alignment at a second location by moving a second structure either:
(a) into the mold cavity to a third position to form, in the part, a third feature that bulges inward, or
(b) away from the mold cavity to a fourth position to form, in the part, a fourth feature that bulges outward.

4. The method of claim 3 comprising moving the first structure into the mold cavity to form a first feature that bulges inward, and moving the second structure away from the mold cavity to form a fourth feature that bulges outward.

5. The method of claim 1 wherein moving the first structure away from the mold cavity comprises adding fiber-bundle-based preforms to the mold cavity.

6. The method of claim 1 wherein altering the first non-random fiber alignment comprises using process-control logic to control timing of the movement of the first structure.

7. The method of claim 1 wherein altering the first non-random fiber alignment comprises controlling timing of the movement of the first structure via pressure in the mold cavity, wherein movement of a spring is triggered by a threshold amount of the pressure, and movement of the spring results in movement of the first structure.

8. A compression-molding method for forming a feature in a part, the compression molding method comprising:
placing an assemblage of fiber-bundle-based preforms in a mold cavity, wherein the assemblage is arranged to achieve a first non-random fiber alignment throughout a part being molded, each fiber-bundle-based preform comprising fiber and resin;
fully consolidating the fiber-bundle-based preforms in the assemblage by the application of heat and pressure, thereby attaining a soak phase of the compression molding process, and wherein the first non-random fiber alignment is achieved;
inducing, during the soak phase, a pressure gradient at a first location in the mold cavity, wherein the pressure gradient alters the first non-random fiber alignment to a second non-random fiber alignment at the first location.

9. The method of claim 8 wherein inducing a pressure gradient at a first location comprises actuating a first structure to move either:
(a) into the mold cavity to a first position to form, in the part, a first feature that bulges inward, or
(b) away from the mold cavity to a second position to form, in the part, a second feature that bulges outward.

10. The method of claim 9 wherein the first structure is actuated by a linear actuator.

11. A compression mold for forming a feature in a part, wherein the feature bulges outward or inward relative to a surface of the part, the compression molding method comprising:
a mold wall;
a mold cavity defined by an inner surface of the mold wall;
a movable structure, wherein, in a quiescent state, a surface of the movable structure forms a portion of the inner surface of the mold wall;
an actuation system, wherein the actuation system is physically adapted to cause the movable structure to move either:
(b) into the mold cavity, or
(b) away from the mold cavity.

12. The compression mold of claim 11 wherein the actuation system comprises a driver and a linkage, wherein the linkage is coupled to the movable structure, and the driver causes the linkage to move.

13. The compression mold of claim 11 wherein the actuation system comprise a linear actuator.
